(19) United States
(12) Patent Application Publication
(10) Pub. No.: US 2013/0238597 A1
(43) Pub. Date: Sep. 12, 2013

(54) METHOD AND SYSTEM FOR ONTOLOGY NAVIGATION AND VISUALIZATION

(71) Applicants: Weng Onn Kow, Kuala Lumpur (MY); Reza Beik Zadeh Mohammad, Kuala Lumpur (MY); Lukose Dickson, Kuala Lumpur (MY)

(72) Inventors: Weng Onn Kow, Kuala Lumpur (MY); Reza Beik Zadeh Mohammad, Kuala Lumpur (MY); Lukose Dickson, Kuala Lumpur (MY)

(73) Assignee: MIMOS BERHAD, Kuala Lumpur (MY)

(21) Appl. No.: 13/260,470

(22) PCT Filed: Mar. 22, 2010
(86) PCT No.: PCT/MY2010/000032

§ 371 Date: Mar. 1, 2013

(30) Foreign Application Priority Data
Mar. 27, 2009 (MY) PI 20091247

(51) Int. Cl. G06F 17/30

(52) U.S. Cl. CPC G06F 17/30554
USPC 707/722

(57) ABSTRACT

A method (100) and system (200) for ontology navigation and visualization, the system (200) comprises an ontology navigator (202). The ontology navigator (202) comprises means for graphically displaying a plurality of concepts (102) of at least one ontology knowledge base (206), receiving a user query of at least one concept from the plurality of concepts (104), identifying a visualization application (204) for visualizing the at least one concept (106), generating an information set (108) of the at least one concept recognized by the visualization application (204), and forwarding the information set (110) of the at least one concept to the visualization application (204).

### FIELD OF INVENTION

The present invention relates to a method and system for ontology navigation and visualization.

### BACKGROUND ART

The expansion of ontology knowledge bases of various domains has yielded in complex graphical displays of the same. Ontology knowledge bases having Resource Description Framework (RDF) triples format represents knowledge in the form of Subject-Predicate-Object (SPO) format. The expansion of concepts of an ontology knowledge base yields in a large number of triples and these triples can be represented as nodes and links in the form of complex graphs.

Visualizing complex graphs in text form as well as graphical form impairs the ability of a user to visualize and understand the concept of interest of the knowledge contained within the ontology knowledge bases. Additionally, some concepts have very specific ways of being displayed and visualized on various visualization applications. Hence it is not practical to acquire all possible visualization applications to reside in a single visualization application in order to support the various ontology knowledge domains.

### SUMMARY OF INVENTION

In one embodiment of the present invention is a method for ontology navigation and visualization. The method comprises graphically displaying a plurality of concepts of at least one ontology knowledge base, receiving a user query of at least one concept from the plurality of concepts, identifying a visualization application for visualizing the at least one concept, generating an information set of the at least one concept recognized by the visualization application and forwarding the information set of the at least one concept to the visualization application.

In another embodiment of the present invention is a system for ontology navigation and visualization. The system comprises an ontology navigator characterized in that the ontology navigator comprises means for graphically displaying a plurality of concepts of at least one ontology knowledge base, receiving a user query of at least one concept from the plurality of concepts, identifying a visualization application for visualizing the at least one concept, generating an information set of the at least one concept recognized by the visualization application and forwarding the information set of the at least one concept to the visualization application.

The present invention consists of several features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF THE ACCOMPANYING DRAWINGS

To further clarify various aspects of some embodiments of the present invention, a more particular description of the invention will be rendered by references to specific embodiments thereof, which are illustrated, in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates a flowchart of a method for ontology navigation and visualization.

FIG. 2 illustrates a block diagram of a system for ontology navigation and visualization.

### DETAILED DESCRIPTION OF THE PREFERRED EMBODIMENTS

The present invention relates to a method and system for ontology navigation and visualization. Hereinafter, this specification will describe the present invention according to the preferred embodiments of the present invention. However, it is to be understood that limiting the description to the preferred embodiments of the invention is merely to facilitate discussion of the present invention and it is envisioned that those skilled in the art may devise various modifications and equivalents without departing from the scope of the appended claims.

The embodiments of the present invention relate to a method and system for ontology navigation and visualization. In particular, the embodiments of the present invention relate to the method and system to support multimodal ontology navigation and visualization. According to the embodiments of the present invention, multimodal navigation and visualization relates to navigating through graphical representations of various domains of ontology knowledge bases and visualizing a concept of interest from the ontology knowledge base using an appropriate and specific visualization application.

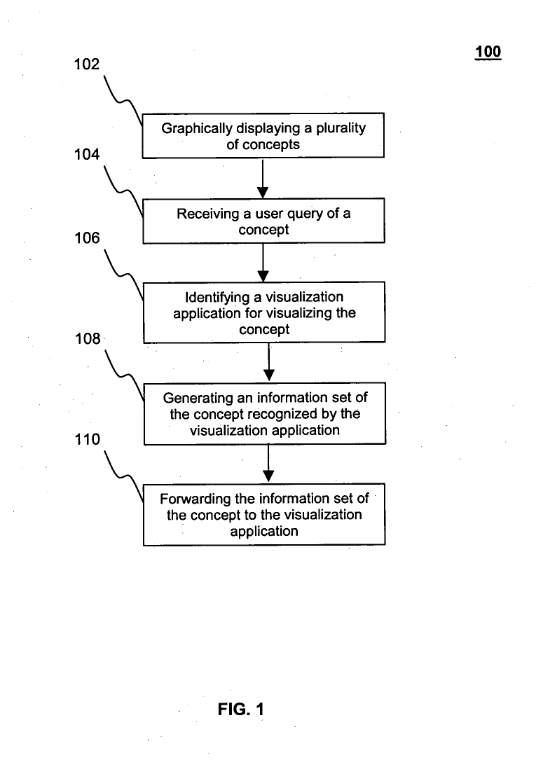

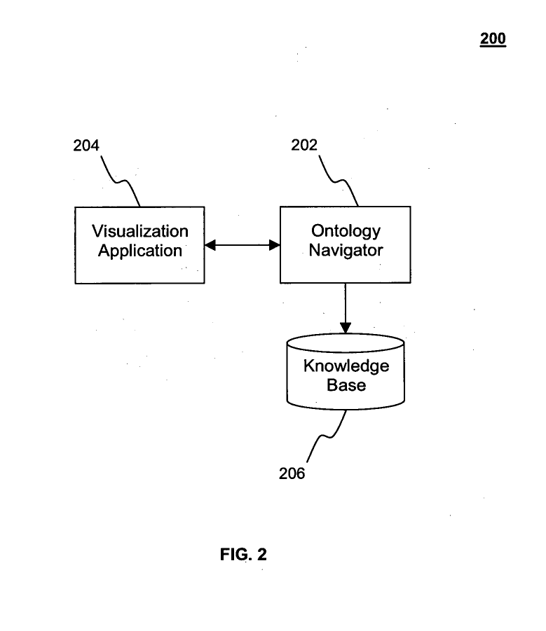

Reference is collectively being made to FIGS. 1 and 2. FIG. 1 illustrates a flowchart of the method (100) for ontology navigation and visualization. FIG. 2 illustrates a block diagram (200) of the system for ontology navigation and visualization.

The system (200) for ontology navigation and visualization as depicted in FIG. 2 comprises an ontology navigator (202). The ontology navigator (202) comprises means for graphically displaying a plurality of concepts (102) of at least one ontology knowledge base (206), receiving a user query of at least one concept from the plurality of concepts (104), identifying a visualization application (204) for visualizing the at least one concept (106), generating an information set (108) of the at least one concept recognized by the visualization application (204), and forwarding the information set (110) of the at least one concept to the visualization application (204). The ontology navigator (202) may reside at the user end or at an intermediate entity.

The ontology navigator (202) is an independent module and is de-coupled from the visualization application (204) and the ontology knowledge base (206). This provides flexibility to support the development of the multimodal ontology navigation and visualization wherein newly discovered ontology knowledge bases and visualization applications may be plugged-in to expand the application of the multimodal ontology navigation and visualization.

The visualization application (204) comprises various internal and external visualization applications. These internal and external visualization applications include 3-Dimensional visualization applications, geographical map visualization applications, web browser applications as well as multimedia applications such as image, audio and video applications. The ontology navigator (202) is synchronized to the visualization application (204) in order to affect the graphical display of the ontology navigator (202) while the user is interacting with the visualization application (204).

The ontology knowledge base (206) comprises knowledge bases having Resource Description Framework (RDF) triples format wherein knowledge is represented in the form of Subject-Predicate-Object (SPO) format. The ontology knowledge base (206) comprises various domains of ontology knowledge bases having a plurality of concepts including concepts from medical, geographical, historical and various other domains.

Due to fact that the knowledge resides within the ontology knowledge base (206) and is semantically tagged, the ontology navigator (202) may be easily adapted to operate with ontology knowledge bases in any domain. The semantic tags may also be used to identify the visualization application (204) for visualizing the at least one concept (106), if necessary, and thus allowing any external visualization application to be plugged-in to operate with the ontology navigator (202).

The ontology navigator (202) comprises means for graphically displaying the plurality of concepts (102) of the at least one ontology knowledge base (206). This comprises graphically displaying the plurality of concepts as a plurality of nodes and links. The graphical display increases in complexity as the number of plurality of concepts of the ontology knowledge base (206) increases. Besides having graphical display, the ontology navigator (202) comprises means for displaying the plurality of concepts of the at least one ontology knowledge base (206) in the HyperText Markup Language (HTML) form as well as taxonomy form.

Using the ontology navigator (202), a user is able to navigate through the plurality of concepts of the at least one ontology knowledge base (206) in the graphical, HTML as well as the taxonomy form in order to select at least one concept from the plurality of concepts of the at least one ontology knowledge base (206) that is of interest. The user selection is received by the ontology navigator (202) as the user query of the at least one concept from the plurality of concepts (104).

In another embodiment of the present invention, the ontology navigator (202) comprises means for receiving a user semantic query of the at least one concept from the plurality of concepts, forwarding the user semantic query for processing and retrieving a semantic query result to identify the at least one concept from the plurality of concepts. In this embodiment, the user provides the semantic query either in the form of a structured natural language query statement or a knowledge base compliant query statement. The ontology navigator (202) then forwards the user semantic query for processing. Upon completion of the user semantic query processing, the ontology navigator (202) retrieves the semantic query result to identify the at least one concept from the plurality of concepts that is of interest.

Upon obtaining the at least one concept from the plurality of concepts that is of interest as selected by the user or retrieved from the processing of the user semantic query, the ontology navigator (202) identifies the visualization application (204) for visualizing the at least one concept (106). The implementation of identifying the visualization application (204) provides the user with a specific visualizer that most appropriate to visualize and understand the concept of the knowledge that is of interest. The method of identifying the visualization application (204) for visualizing the at least one concept (106) comprises identifying a type of concept of the at least one concept.

Identifying, the type of concept of the at least one concept is achieved by either identifying a class of the at least one concept, identifying a relation of the at least one concept to other concepts or identifying at least one property of the at least one concept.

In the case of identifying the class of the concept, for example, a concept that is an instance of the “image” class is identified as having an image type of concept. This concept is best viewed and understood by an image application, such as an image viewer. In this case, an image application is identified as the visualization application (204) for visualizing the at least one concept (106). The image file or the Uniform Resource Locater (URL) pointing to the location of the image file is used to visualize the image file on the image application.

In the case of identifying the relation of the at least one concept to other concepts, for example a concept of the relation “homepage” is identified as having a website type of concept, wherein the relation is a website which is the homepage of the other concept. In this case, an web browser application is identified as the visualization application (204) for visualizing the at least one concept (106). The URL content is passed to the web browser application to visualize the homepage.

In the case of identifying the properties of the at least one concept, for example, a concept that has a latitude property as well as a longitude property is identified as having a geographical map type of concept. This concept is best viewed and understood by a geographical map visualization application, such as Google Earth. In this case, a geographical map visualization application is identified as the visualization application (204) for visualizing the at least one concept (106). The latitude and longitude information is used obtain a point of mapping on Google Earth.

In other examples, for a concept selected from the ontology knowledge base of medical knowledge, a 3-Dimensional application may be identified to visualize the said concept.

Upon identifying the visualization application for visualizing the at least one concept (106), the ontology navigator (202) generates the information set (108) of the at least one concept recognized by the visualization application. Generating the information set (108) of the at least one concept recognized by the visualization application comprises extracting required information related to the at least one concept from the ontology knowledge base (206) and formatting the required information to form the information set of the at least one concept recognized by the visualization application (204).

For example, where the at least one concept selected by the user or retrieved from the processing of the user semantic query is a bone from the ontology knowledge base of medical knowledge, a 3-Dimensional application is identified as the visualization application for visualizing the same. The ontology navigator (202) extracts all the required information including all the knowledge related to the concept of the bone from the ontology knowledge base of medical knowledge, such as the name of the bone, model of the bone, viewing properties such as angle, rotation and zoom as well as specific knowledge such as bones with injuries such as fractures and tumours.

In another example, where the at least one concept selected by the user or retrieved from the processing of the user semantic query is a geographical feature having latitude and longitude properties for instance a town from the ontology knowledge base of geographical knowledge, a geographical map visualization application is identified as the visualization application for visualizing the same. The ontology navigator (202) extracts all the required information including all the knowledge related to the concept of the town from the ontology knowledge base of geographical knowledge, such as the name of the town, population information and other related information.

The extracted information is formatted to form the information set of the at least one concept recognized by the visualization application. The ontology navigator (202) then forwards the information set (110) of the at least one concept to the visualization application (204). The information set is displayed on the visualization application (204) and the user is able to visualize and understand the concept of interest from the ontology knowledge base (206) through the visualization application (204). The interaction between the user and the visualization application (204) is affected in the graphical display of the ontology navigator (202).

1. A method (100) for ontology navigation and visualization, the method (100) comprises
graphically displaying a plurality of concepts (102) of at least one ontology knowledge base;
receiving a user query of at least one concept from the plurality of concepts (104);
identifying a visualization application for visualizing the at least one concept (106);
generating an information set (108) of the at least one concept recognized by the visualization application; and
forwarding the information set (110) of the at least one concept to the visualization application.

2. The method (100) according to claim 1, wherein graphically displaying the plurality of concepts (102) of the at least one ontology knowledge base further comprises graphically displaying the plurality of concepts as a plurality of nodes and links.

3. The method (100) according to claim 1, wherein receiving the user query of the at least one concept from the plurality of concepts (104) further comprises
receiving a user semantic query of the at least one concept from the plurality of concepts;
forwarding the user semantic query for processing; and
retrieving a semantic query result to identify the at least one concept from the plurality of concepts.

4. The method (100) according to claim 1, wherein identifying the visualization application for visualizing the at least one concept (106) further comprises identifying a type of concept of the at least one concept.

5. The method (100) according to claim 4, wherein identifying the type of concept of the at least one concept further comprises identifying a class of the at least one concept, identifying a relation of the at least one concept or identifying at least one property of the at least one concept.

6. The method (100) according to claim 1, wherein generating the information set (108) of the at least one concept recognized by the visualization application further comprises
extracting required information related to the at least one concept from the ontology knowledge base; and
formatting the required information to form the information set of the at least one concept recognized by the visualization application.

7. A system (200) for ontology navigation and visualization, the system (200) comprises an ontology navigator (202) characterized in that the ontology navigator (202) comprises means for
graphically displaying a plurality of concepts of at least one ontology knowledge base (206);
receiving a user query of at least one concept from the plurality of concepts;
identifying a visualization application (204) for visualizing the at least one concept;
generating an information set of the at least one concept recognized by the visualization application (204); and
forwarding the information set of the at least one concept to the visualization application (204).

8. The system (200) according to claim 7, wherein the ontology navigator (202) further comprises means for
graphically displaying the plurality of concepts as a plurality of nodes and links;
receiving a user semantic query of the at least one concept from the plurality of concepts;
performing a semantic query to identify the at least one concept from the plurality of concepts;
identifying a type of concept of the at least one concept;
extracting required information related to the at least one concept from the ontology knowledge base (206); and
formatting the required information to form the information set of the at least one concept recognized by the visualization application (204).

9. The system (200) according to claim 7, wherein the ontology navigator (202) further comprises means for identifying a class of the at least one concept, identifying a relation of the at least one concept or identifying at least one property of the at least one concept.
